(19) United States
(12) Patent Application Publication
(10) Pub. No.: US 2011/0276586 A1
(43) Pub. Date: Nov. 10, 2011

(54) METHOD FOR ESTABLISHING INFORMATION NETWORK

(75) Inventors: Myungwon Jung, Seoul (KR); Seunggon Kim, Seoul (KR); Sanghun Kim, Seoul (KR); Songhwa Chae, Seoul (KR)

(73) Assignee: AKASPACE INC., Seoul (KR)

(21) Appl. No.: 12/989,415

(22) PCT Filed: Apr. 1, 2009
(86) PCT No.: PCT/KR2009/001632

§ 371 Date: Nov. 29, 2010

(30) Foreign Application Priority Data
Apr. 29, 2008 (KR) 10-2008-0039804

(51) Int. Cl. G06F 17/30

(52) U.S. Cl. 707/769; 707/803; 707/E17.014

(57) ABSTRACT

A method of establishing an information network comprises the steps of obtaining first information generated by a computing apparatus, obtaining second information generated by the computing apparatus and configured to describe the first information, obtaining third information generated by the computing apparatus and configured to indicate a relationship between the first information and a user who owns the first information, and associating the second and third pieces of information with the received first information.

### CROSS-REFERENCES TO RELATED APPLICATION

Priority to Korean patent application number 10-2008-0039804 filed on Apr. 29, 2008, the entire disclosure of which is incorporated by reference herein, is claimed.

### BACKGROUND OF THE INVENTION

1. Field of the Invention

Embodiments relate to a method of establishing an information network.

2. Background of the Related Art

Today, with the rapid development of the Internet, a user can generate information himself or generate information on the basis of information generated by the others. For example, a user can generate information about a food using a computing apparatus, such as a desktop computer, a cellular phone, or Personal Digital Assistants (PADs). For another example, a user can generate information about a food using at least some of information generated by the others.

A user can generate information about a food by taking a specific relationship with the food into consideration. However, the others who see the information about a food generated by the user do not know that the user has generated the information about a food with what intention.

### SUMMARY OF THE INVENTION

In accordance with an embodiment, a method of establishing an information network comprises the steps of obtaining first information generated by a computing apparatus, obtaining second information generated by the computing apparatus and configured to describe the first information, obtaining third information generated by the computing apparatus and configured to indicate a relationship between the first information and a user who owns the first information, and associating the second and third pieces of information with the received first information.

In accordance with an embodiment, a method of establishing a knowledge information network comprises the steps of generating a home information page including a description of a user and generating knowledge information pages which can be connected by the home information page. The step of generating the knowledge information page comprises the steps of obtaining first information generated by a computing apparatus, obtaining second information generated by the computing apparatus and configured to describe the first information, obtaining third information generated by the computing apparatus and configured to indicate a relationship between the first information and a user who owns the first information, and associating the second and third pieces of information with the received first information.

In accordance with an embodiment, an apparatus for establishing a knowledge information network comprises means for generating a home information page including a description of a user and means for generating knowledge information pages which can be connected by the home information page. The means for generating the knowledge information page comprises means for obtaining first information generated by a computing apparatus, means for obtaining second information generated by the computing apparatus and configured to describe the first information, means for obtaining third information generated by the computing apparatus and configured to indicate a relationship between the first information and a user who owns the first information, and means for associating the second and third pieces of information with the received first information.

### BRIEF DESCRIPTION OF THE DRAWINGS

FIG. 1 is a diagram illustrating an information network according to an embodiment;

FIG. 2 is a flowchart illustrating a process of establishing the information network of FIG. 1;

FIG. 3 is a diagram illustrating an apparatus for establishing the information network;

FIG. 4 is a diagram illustrating a process of associating second and third pieces of information with first information; and

FIGS. 5 to 7 are diagrams illustrating a process of searching the information network according to an embodiment of the present invention.

### DETAILED DESCRIPTION OF EMBODIMENTS

Descriptions of embodiments are only illustrative for the purpose of structural or functional descriptions. The scope should not be construed to be limited to the following embodiments, but should be construed to cover the equivalents which can realize the technical spirit of the embodiments.

Meanwhile, the meanings of terms described in the specification should be understood as follows.

Terms, such as “first” and “second”, are used to distinguish one element from the other element, and the scope should not be limited to the terms. For example, a first element can be named a second element. Likewise, a second element can be named a first element.

A term “and/or” should be understood to include all combinations which can be presented from one or more pertinent items. For example, “a first item, a second item, and/or a third item” means “at least one or more of the first item, the second item, and the third item” and means a combination of all items which can be presented from two or more of not only the first, second, or third item, but the first, second, and third items.

In case where one element is described to be “connected” to the other element, the one element may be directly connected the other element, but it should be understood that a third element may exist between the two elements. On the other hand, in case where one element is described to be “directly connected” to the other element, it should be understood that a third element does not exist between the two elements. The same principle applies to other expressions, such as “between ˜” and “just between ˜” or “adjacent to ˜” and “adjacent just to ˜”, which describe a relationship between elements.

An expression of the singular number should be understood to include plural expressions apparently not given otherwise in the context. Terms, such as “include” or “have”, should be understood to indicate the existence of a set characteristic, numbers, a step, an operation, an element, a part, or a combination of them and not to exclude the existence or additional possibilities of one or more other characteristics, numbers, steps, operations, elements, parts, or a combination of them.

Steps can be performed unlike a written order unless a specific order is apparently described in the context. That is, the steps may be performed according to the written order, performed substantially at the same time, and performed in reverse order.

All terms used herein, unless otherwise defined herein, have the same meanings which are typically understood by those having ordinary skill in the art. Terms, such as ones defined in common dictionaries, should be interpreted to have the same meanings as terms in the context of pertinent technology, and should not be interpreted to have ideal or excessively formal meanings unless clearly defined in the specification.

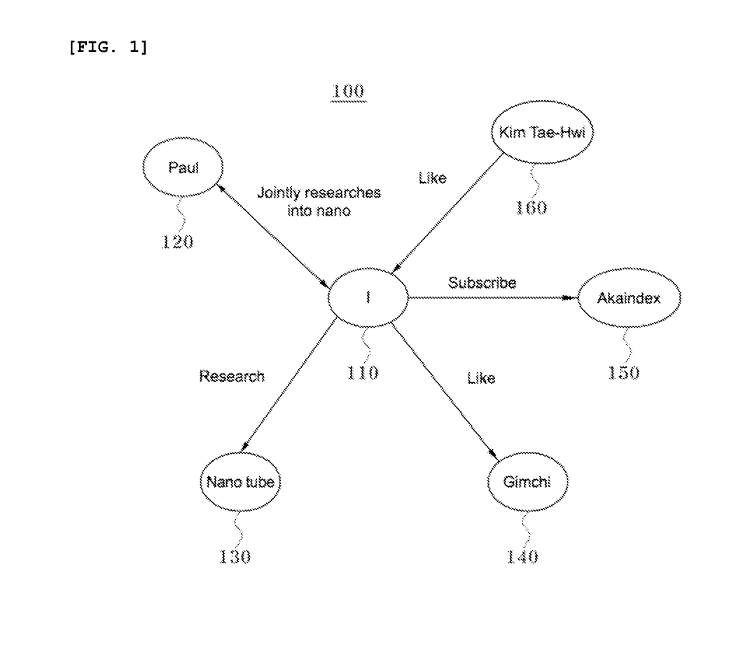

FIG. 1 is a diagram illustrating an information network according to an embodiment.

Referring to FIG. 1, the information network 100 includes pieces of information associated therewith around a user 110.

Paul 120 corresponds to a person who researches into nano in partnership with the user 110 and can correspond to another user of the information network 100. Paul 120 has personality, and bilateral relations (e.g., ‘jointly research nano’) between the user 110 and Paul 120 are defined. Thus, the user 110 and Paul 120 can share a counterpart's information.

A nano tube 130 corresponds to the object into which the user 110 researches and does not have personality. A one-sided relationship with the nano tube 130 is defined by the user 110. Since a one-sided relationship (e.g., ‘research’) between the user 110 and the nano tube 130, the user 110 can generate information pertinent to the nano tube 130 himself or collect pieces of information generated by the others.

Gimchi 140 corresponds to the object liked by the user 110 and does not have personality. A one-sided relationship with the gimchi 140 is defined by the user 110. Since a one-sided relationship (e.g., ‘like’) between the user 110 and the gimchi 140 is defined, the user 110 can generate information pertinent to the gimchi 140 himself or collect pieces of information generated by the others.

An Akaindex 150 corresponds to an Internet site to which the user 110 has subscribed and has personality. A one-sided relationship with the Akaindex 150 is defined by the user 110. The Akaindex 150 corresponds to the object which can be managed by persons and thus has personality even though it corresponds to a lifeless thing. Since a one-sided relationship (e.g., ‘subscribe’) between the user 110 and the Akaindex 150 is defined, the user 110 can access information made public in the Akaindex 150.

Kim Tae-Hwi 160 corresponds to a person who likes the user 110 and has personality. A one-sided relationship (e.g., ‘like’) with the user 110 is defined by Kim Tae-Hwi 160. Kim Tae-Hwi 160 can access information made public by the user 110.

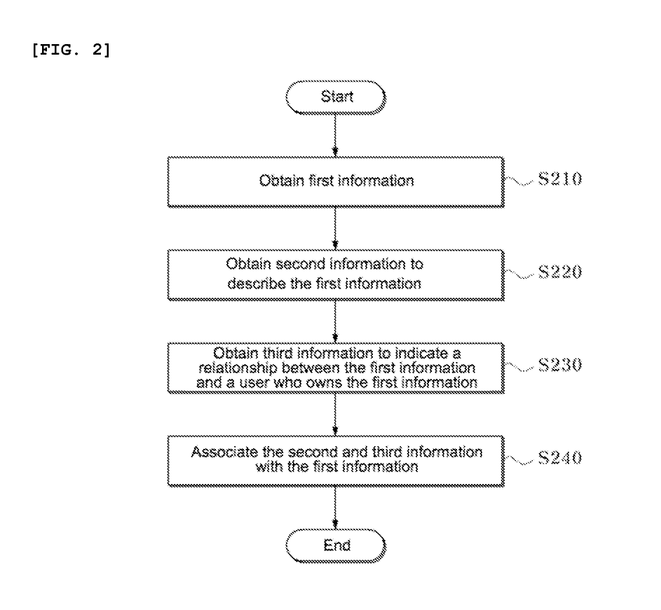

FIG. 2 is a flowchart illustrating a process of establishing the information network of FIG. 1.

The information network 100 can be established by a server (not shown). Here, the server (not shown) is accessible over the Internet or a computer network, and it can store at least some of information necessary for the user 110.

The server (not shown) obtains first information generated by a computing apparatus (not shown) at step S210. In accordance with an embodiment, the first information can be directly produced by the user 110 or can be constructed of information produced by the others. For example, in case where the first information corresponds to information about the gimchi 140, the user 110 can directly produce information about the gimchi 140 or can link or embed information about the gimchi 140 produced by the others.

In accordance with an embodiment, the first information can correspond to information about the others having relation to the user 110 (i.e., the object having personality). For example, in case where the first information can correspond to information about Paul 120 and corresponds to the information about Paul 120, the first information can correspond to information chiefly made public by Paul 120.

In accordance with an embodiment, at least some of the first information can be constructed of information produced by the others. For example, in case where the first information includes a figure and writings, the figure can correspond to information produced by the others. In some implementations, at least some of the first information can correspond to information to and in which information produced by the others is linked and embedded.

The server (not shown) obtains second information generated by a computing apparatus (not shown) and configured to describe the first information at step S220. In accordance with an embodiment, the second information can be inputted by the user 110 or it can describe at least some of the first information. For example, in case where the first information corresponds to information about the gimchi 140, the second information can correspond to cabbage gimchi.

In accordance with another embodiment, the second information can be generated on the basis of a word of high frequency in the first information. For example, in case where a term “cabbage gimchi” is of the highest frequency in the first information, the second information can correspond to cabbage gimchi.

The server (not shown) obtains third information generated by a computing apparatus (not shown) and configured to indicate a relationship between the first information and the user 110 who owns the first information at step S230. The third information can correspond to verb-based information which sets up a relationship between the user 110 and the first information. For example, in FIG. 1, the third information can correspond to “jointly research nano”, “like”, “research”, and “subscribe”.

In accordance with an embodiment, the third information can correspond to verb-based information which sets up a one-sided relationship or bilateral relations between the user 110 and the first information. For example, in case where the first information has personality, a one-sided relationship or bilateral relations between the user 110 and the first information can be set up. For another example, in case where the first information does not have personality, a one-sided relationship between the user 110 and the first information can be set up.

In accordance with an embodiment, the third information can be selected from at least one verb-based information set up on the basis of the user 110 and/or the first information. For example, the user 110 can select one of pieces of predetermined verb-based information as the third information.

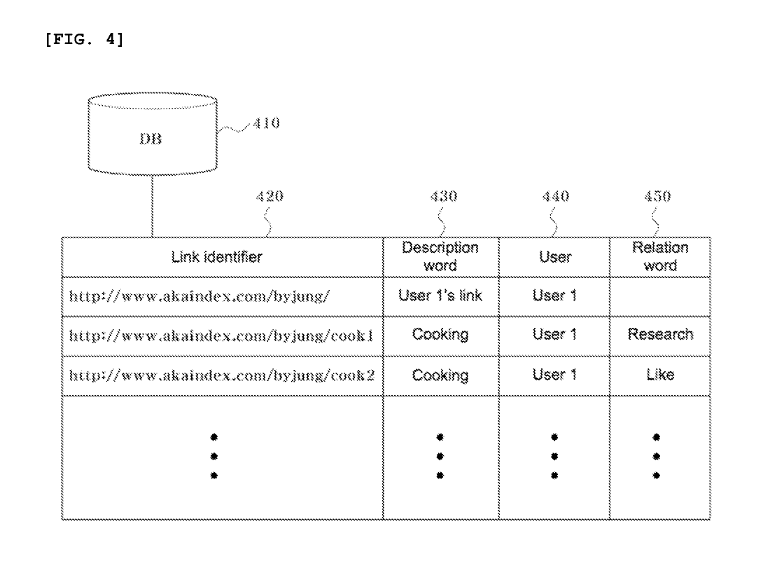

The server (not shown) associates the second and third pieces of information with the first information at step S240. Accordingly, a relationship between the user 110 and the first information becomes clear. The association by the server (not shown) is described later with reference to FIG. 4.

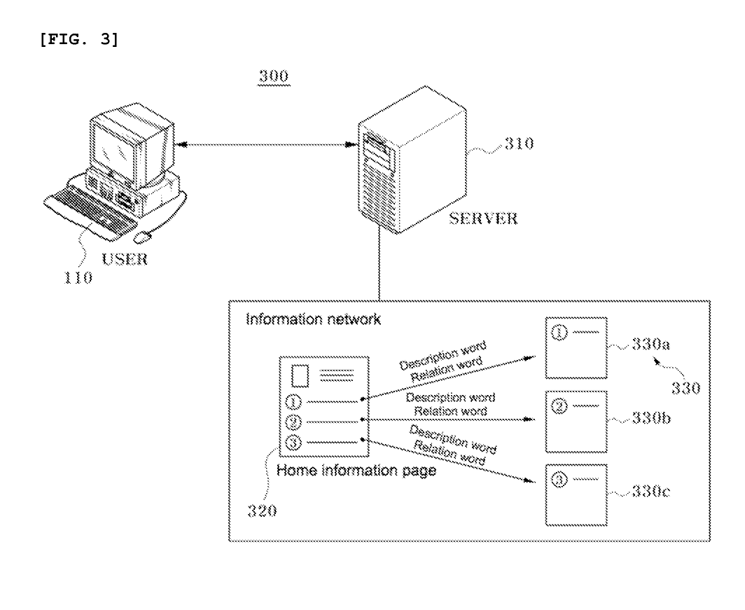

FIG. 3 is a diagram illustrating an apparatus for establishing the information network.

Referring to FIG. 3, the apparatus for establishing the information network (hereinafter referred to as an “information network establishment apparatus”) 300 includes a server 310 accessible to a user 110. Meanwhile, the information network can be implemented using a knowledge information network in order to provide knowledge information to users.

The server 310 can generate a home information page 320 including a description of the user 110. That is, the home information page 320 includes information, corresponding to the first information and about the object with personality. For example, the home information page 320 can include personal information inputted by the user 110 and the range of disclosure determined by the user 110.

The server 310 generates knowledge information pages 330 (330a, 330b, and 330c) which can be connected by the home information page 320. That is, the knowledge information pages 330 include information, corresponding to the first information and about the object not having personality. For example, the knowledge information pages 330a can include information about the nano tube 130 of FIG. 1, and the knowledge information pages 330b can include information about the gimchi 140 of FIG. 1.

The home information page 320 can define a description word (i.e., the second information) to describe the knowledge information pages 330 (i.e., the first information) and a relation word (i.e., the third information) between the knowledge information pages 330 and a user of the home information page 320. That is, the knowledge information pages 330 are accessible to the home information page 320.

FIG. 4 is a diagram illustrating a process of associating second and third pieces of information with first information.

Referring to FIG. 4, an association database (DB) 410 is included in the server 310. The association database 410 includes a link identifier field 420, a description word field 430, a user field 440, and a relation word field 450.

When the knowledge information pages 330 (i.e., the first information) are produced by the user 110, the server 310 associates the second and third pieces of information with the first information. The server 310 generates a link identifier which can access the knowledge information pages 330 and constructs the database 410 by associating the description word (i.e., the second information) and the relation word (i.e., the third information) with the link identifier.

For example, when the user 110 corresponding to an ID “byjung” produces a home information page, the server 310 generates a link identifier (e.g., http://www.akaindex.com/byjung/) corresponding to the home information page. In accordance with an embodiment, a relation word can be omitted from the home information page.

When the user 110 generates a knowledge information page relating to cooking and designates “cooking” as a description word and “research” as a relation word, the server 310 can generate http:/www.akaindex.com/byjung/cook1 as the link identifier of the knowledge information page and constructs a database by associating the description word “cooking” and the relation word “research” with the link identifier.

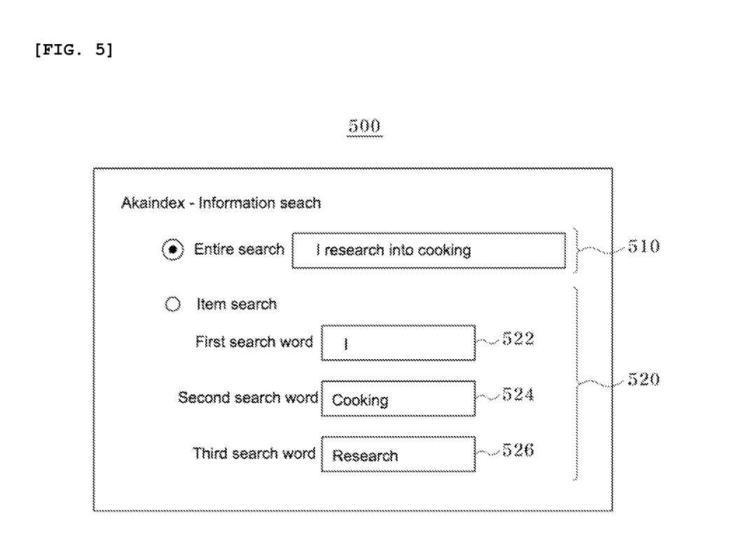

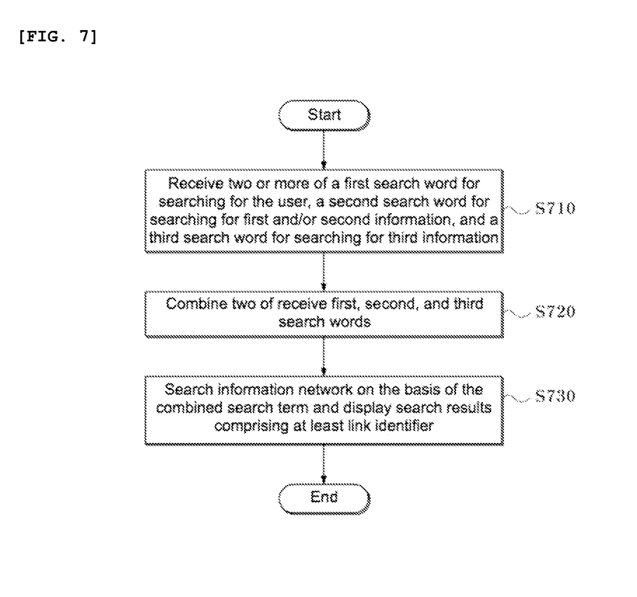

FIGS. 5 to 7 are diagrams illustrating a process of searching the information network according to an embodiment of the present invention.

In FIG. 5, an apparatus for searching the information network (hereinafter referred to as an ‘information network search apparatus’) (not shown) refers to an input interface 500 through which the user 110 inputs information in order to search for information. In accordance with an embodiment, the information network search apparatus can be implemented in the information establishment network apparatus. In accordance with another embodiment, the information network search apparatus can be implemented an additional server.

The input interface 510 includes first input means 510 and second input means 520.

The first input means 510 can receive a search term through one text box, and the second input means 520 can receive search words through a plurality of text boxes.

The search term or the search words inputted to the first input means 510 or the second input means 520 include two or more of a first search word for searching for a user, a second search word for searching for the first and/or second information (e.g., a knowledge information page and/or a description word), and a third search word for searching for the third information (e.g., a relation word).

The information network search apparatus (not shown) receives two or more of the first search word, the second search word, and the third search word at step S710.

The information network search apparatus (not shown) combines two of the first, second, and third search words at step S720. For example, in case where a sentence “I research into cooking” is inputted to the first input means 510 or words “I”, “cooking”, and “research” are respectively inputted to the input means 522, 524, and 526 of the second input means 520, the information network search apparatus (not shown) constructs a first combination of the word “I” and the word “cooking”, a second combination of the word “I” and the word “research”, and a third combination of the word “cooking” and the word “research”.

In accordance with an embodiment, in case where synonyms of a relation word are defined, combinations can be constructed on the basis of two of the first search word, the second search word, and the synonyms. This is because a relationship between a user and a searcher can be contrary to each other. For example, from a viewpoint of the user, a relation word can correspond to “buy”. From a standpoint of the searcher, the relation word can correspond to “sell”.

The information network search apparatus (not shown) searches the information network on the basis of the combined search words and displays the search results including link identifiers at step S730. For example, the combined search words can correspond to the first, second, or third combination.

The information network search apparatus (not shown) can repeatedly combine two of the first, second, and third search words, search for the information network on the basis of the combined search words, and display the search results including link identifiers. In accordance with an embodiment, the search results can further include at least some of the first information (e.g., the knowledge information page). This can be for convenience of a searcher.

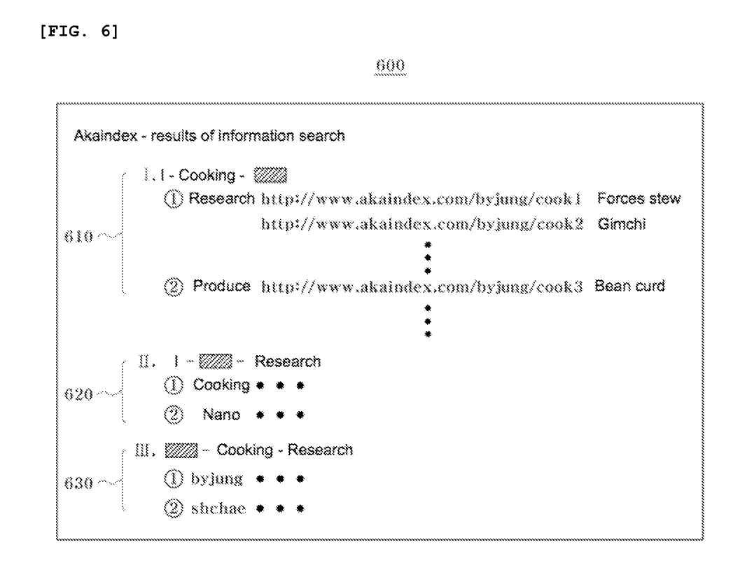

In FIG. 6, search results 600 include first output results 610, second output results 620, and third output results 630.

The first output results 610 indicate the results of searching the information network on the basis of the first and second search words. The second output results 620 indicate the results of searching the information network on the basis of the first and third search words. In case where the first search word is inputted, the information network search apparatus (not shown) can inform the others, having relation to the second and/or third search words, of information about the first search word. That is, the information network search apparatus (not shown) can inform an interested user of information about who has searched for specific information using a specific relationship. Accordingly, the interested user can utilize the information about who has searched for specific information using a specific relationship.

The third output results 630 indicate the results of searching the information network on the basis of the second and third search words.

Meanwhile, FIGS. 5 to 7 have been illustrated on the basis of an active relationship, but those skilled in the art can easily implement a passive relationship.

For example, from a viewpoint of the passive relationship, the information network search apparatus (not shown) can interpret a relationship between the first and/or second information and between the user and the first and/or second information and inform who has connected the first and/or second information using which relationship.

Meanwhile, the methods performed by the information network establishment apparatus (not shown), the knowledge information network establishment apparatus (not shown), and the information network search apparatus (not shown) can be implemented using a computer program. Accordingly, a storage medium for storing commands to execute the methods can also be easily implemented.

While some exemplary embodiments of the present invention have been described, those skilled in the art will appreciate that the embodiments can be modified in various ways without departing from the scope and spirit of the present invention.

### INDUSTRIAL APPLICABILITY

The above-described embodiments can have effects including the following advantages. However, all the embodiments are not meant to include all the advantages or a specific embodiment is not meant to include only the following advantages. Accordingly, it is not to be understood that the scope is limited thereto.

In accordance with an embodiment, an information network can be efficiently established by assigning the characteristic of a network or a link between an information entity and an information entity on the basis of a relationship between information and a user who owns the information.

In accordance with an embodiment, an information network can be efficiently searched by searching for not only information, but also a relationship between information and a user who owns the information.

In accordance with an embodiment, which users have connected specific pieces of information using specific relationships can be known by interpreting information and a relationship between a user and the information. That is, in accordance with an embodiment, interpretation can be performed on the basis of a passive relationship in which information is the subject.

For example, a case where a user defines a relationship between information about a food and a term ‘wants to make a thing together’ can be different from a case where a user defines a relationship between information about a food and a term ‘wants to eat together’.

What is claimed is:

1. A method of establishing an information network, comprising the steps of:
obtaining first information generated by a computing apparatus;
obtaining second information generated by the computing apparatus and configured to describe the first information;
obtaining third information generated by the computing apparatus and configured to indicate a relationship between the first information and a user who owns the first information; and
associating the second and third pieces of information with the received first information.

2. The method as claimed in claim 1, wherein the third information corresponds to verb-based information to define the relationship between the user and the first information.

3. The method as claimed in claim 2, wherein the third information corresponds to verb-based information to define a one-sided relationship or bilateral relations between the user and the first information.

4. The method as claimed in claim 2, wherein the third information is selected from at least one verb-based information, set up by the user or on the basis of the first information or both.

5. The method as claimed in claim 1, wherein the first information corresponds to information about others having relation to the user.

6. The method as claimed in claim 1, wherein the second information is received from the user or indicates at least some of the first information.

7. The method as claimed in claim 1, wherein the second information is generated on the basis of a word of high frequency in the first information.

8. The method as claimed in claim 1, wherein the step of obtaining the first information comprises the step of constructing information directly produced by the user or produced by others.

9. The method as claimed in claim 1, wherein the step of obtaining the first information comprises the step of constructing at least some of the first information into information produced by others.

10. The method as claimed in claim 9, wherein the step of constructing at least some of the first information into information produced by others comprises the step of linking or embedding the information produced by the others.

11. The method as claimed in claim 1, wherein the step of associating the second and third pieces of information with the received first information comprises the steps of:
generating a link identifier which can access the first information; and
establishing a database by associating the second and third pieces of information with the link identifier.

12. The method as claimed in claim 11, further comprising the step of storing the first information as information corresponding to the link identifier.

13. A method of establishing a knowledge information network, comprising the steps of:
generating a home information page including a description of a user; and
generating knowledge information pages which can be connected by the home information page,
wherein the step of generating the knowledge information page comprises the steps of:
obtaining first information generated by a computing apparatus;
obtaining second information generated by the computing apparatus and configured to describe the first information;
obtaining third information generated by the computing apparatus and configured to indicate a relationship between the first information and a user who owns the first information; and
associating the second and third pieces of information with the received first information.

14. The method as claimed in claim 13, wherein the third information corresponds to verb-based information to define the relationship between the user and the first information.

15. The method as claimed in claim 14, wherein the third information corresponds to verb-based information to define a one-sided relationship or bilateral relations between the user and the first information.

16. The method as claimed in claim 15, wherein the third information is selected from at least one verb-based information, set up by the user or on the basis of the first information or both.

17. The method as claimed in claim 13, wherein the first information corresponds to information about others having relation to the user.

18. The method as claimed in claim 13, wherein the second information is received from the user or indicates at least some of the first information.

19. The method as claimed in claim 13, wherein the second information is generated on the basis of a word of high frequency in the first information.

20. An apparatus for establishing an information network, comprising:
means for obtaining first information generated by a computing apparatus;
means for obtaining second information generated by the computing apparatus and configured to describe the first information;
means for obtaining third information generated by the computing apparatus and configured to indicate a relationship between the first information and a user who owns the first information; and
means for associating the second and third pieces of information with the received first information.

21. An apparatus for establishing a knowledge information network, comprising:
means for generating a home information page including a description of a user; and
means for generating knowledge information pages which can be connected by the home information page,
wherein the means for generating the knowledge information page comprises:
means for obtaining first information generated by a computing apparatus;
means for obtaining second information generated by the computing apparatus and configured to describe the first information;
means for obtaining third information generated by the computing apparatus and configured to indicate a relationship between the first information and a user who owns the first information; and
means for associating the second and third pieces of information with the received first information.

22. A computer-readable storage medium for storing commands to enable a computer to execute a method of establishing an information network, the method comprising the steps of:
obtaining first information generated by a computing apparatus;
obtaining second information generated by the computing apparatus and configured to describe the first information;
obtaining third information generated by the computing apparatus and configured to indicate a relationship between the first information and a user who owns the first information; and
associating the second and third pieces of information with the received first information.

23. A computer-readable storage medium for storing commands to enable a computer to execute a method of establishing a knowledge information network, the method comprising the steps of:
generating a home information page including a description of a user; and
generating knowledge information pages which can be connected by the home information page,
wherein the step of generating the knowledge information page comprises the steps of:
obtaining first information generated by a computing apparatus;
obtaining second information generated by the computing apparatus and configured to describe the first information;
obtaining third information generated by the computing apparatus and configured to indicate a relationship between the first information and a user who owns the first information; and
associating the second and third pieces of information with the received first information.

24. A method of searching for an information network in an information network in which second information to describe first information and third information to indicate a relationship between the first information and a user who owns the first information are associated with a link identifier which can access the first information, the method comprising the steps of:
receiving two or more of a first search word for searching for the user, a second search word for searching for the first and/or second information, and a third search word for searching for the third information;
combining two of the received first, second, and third search words; and
searching the information network on the basis of the combined search term and displaying the search results comprising at least the link identifier.

25. The method as claimed in claim 24, further comprising the step of repeating the step of combining two of the received first, second, and third search words and the step of displaying the search results comprising at least the link identifier.

26. The method as claimed in claim 24, wherein the step of combining two of the received first, second, and third search words comprises the step of, in case where synonyms of the third search word is defined, combining two of the first search word, the second search word, and the synonyms.

27. The method as claimed in claim 24, wherein the search results further comprise at least some of the first information.

28. The method as claimed in claim 24, further comprising the step of informing others, having relation to the second and/or third search words, of information about the first search word, in case where the first search word is inputted.

29. The method as claimed in claim 24, further comprising the step of informing who has connected the first and/or second information using which relationship by interpreting a relationship between the first and/or second information and between the user and the first and/or second information.

30. An apparatus for searching for an information network in an information network in which second information to describe first information and third information to indicate a relationship between the first information and a user who owns the first information are associated with a link identifier which can access the first information, the apparatus comprising:
means for receiving two or more of a first search word for searching for the user, a second search word for searching for the first and/or second information, and a third search word for searching for the third information;
means for combining two of the received first, second, and third search words; and
means for searching the information network on the basis of the combined search term and displaying the search results comprising at least the link identifier.

31. A computer-readable storage medium for storing commands to enable a computer to execute a method of searching an information network in which second information to describe first information and third information to indicate a relationship between the first information and a user who owns the first information are associated with a link identifier which can access the first information, the method comprising the steps of:
receiving two or more of a first search word for searching for the user, a second search word for searching for the first and/or second information, and a third search word for searching for the third information;
combining two of the received first, second, and third search words; and
searching the information network on the basis of the combined search term and displaying the search results comprising at least the link identifier.
